(19) United States
(12) Patent Application Publication
(10) Pub. No.: US 2025/0105388 A1
(43) Pub. Date: Mar. 27, 2025

(54) INTEGRATED COOLING STRUCTURE

(71) Applicant: SPEED CHARGE, LLC, Carter Lake, IA (US)

(72) Inventors: Arvinth Rathinam, Sunnyvale, CA (US); Richard Steele, Pflugerville, TX (US); Nicholas Seroff, San Jose, CA (US)

(21) Appl. No.: 18/373,761

(22) Filed: Sep. 27, 2023

(51) Int. Cl. H01M 10/613; H01M 10/625; H01M 10/6551

(52) U.S. Cl. CPC H01M 10/613; H01M 10/6551; H01M 10/625

(57) ABSTRACT

An integrated battery cooling module including a battery stack having a top end, a front end, a bottom end separated from the top end by a height of the front end, a back end separated from the front end by a length of the top end. The integrated battery cooling module also includes a frame at least partially enclosing the battery stack on the front end and the back end, the frame compressing the battery stack between the front end and the back end. Further, the integrated battery cooling module includes a cooling plate bonded to and structurally reinforcing the frame and in physical contact with one of the top end and the bottom end of the battery stack.

### FIELD

The present disclosure relates to cooling structures and, more particularly, to integrated cooling structures.

### BACKGROUND

Electrical energy can be stored in batteries and conveyed via electrically conductive materials. In such examples, the batteries and conductive materials will heat up when electrical energy is conveyed. The amount of heat generated is typically proportional to the amount of electrical energy being conveyed

In some examples, the electrical components convey energy and the heat generated in passing electrical energy dissipates via natural convection. In other examples, the heat generated by electrical components is sufficiently great that the electrical components require a cooling structure.

### SUMMARY

Disclosed herein is an integrated battery cooling module. The integrated battery cooling module includes a battery stack having a top end, a front end, a bottom end separated from the top end by a height of the front end, a back end separated from the front end by a length of the top end. The integrated battery cooling module also includes a frame at least partially enclosing the battery stack on the front end and the back end, the frame compressing the battery stack between the front end and the back end. Further, the frame includes a cooling plate bonded to and structurally reinforcing the frame and in physical contact with one of the top end and the bottom end of the battery stack.

In some variations, the cooling plate is a first cooling plate and further comprising a second cooling plate bonded to the frame and in physical contact with the other of the top and the bottom end of the battery stack. In some such variations, the first and second cooling plates each include a plurality of cooling fins. Alternatively, in other examples, the first and second cooling plates each include cooling channels for circulating liquid. In such examples, the cooling channels serpentine between the front end and the back end.

In other variations, the cooling plate is one of an air-cooling heat sink and a liquid-cooling heat sink and the cooling plate is interchangeable with the other of the air-cooling plate and the liquid-cooling plate. The cooling plate is bonded to the battery stack via a thermal adhesive. Alternatively, the cooling plate is integrally formed with the frame.

Also disclosed herein is another integrated battery cooling module. The integrated battery cooling module includes a battery stack having a top end, a bottom end, a front end, a back end, a first side, and a second side. Additionally, the integrated battery cooling module includes a frame at least partially enclosing the battery stack on the front end, back end, first side, and second side. Further, the integrated battery cooling module includes a cooling plate bonded to the frame and in physical contact with one of the top end and the bottom end of the battery stack, the cooling plate including a plurality of cooling fins.

In some variations, the cooling plate is a first cooling plate and further comprising a second cooling plate disposed on the other one of the top end and the bottom end. Additionally, the cooling plate may extend from the front end, back end, first side, and second side of the frame. In some such examples, the cooling fins may extend from the first side to the second side.

In other variations, the battery stack is compressed by the frame between the front end and the back end. In some such examples, the cooling plate is bonded to the battery stack via a thermal adhesive.

Also disclosed herein is another integrated battery cooling module. The integrated battery cooling module includes a battery stack having a top end, a bottom end, a front end, a back end, a first side, and a second side. The integrated battery cooling module also includes a frame at least partially enclosing the battery stack on the front end, back end, first side, and second side. Additionally, the integrated battery cooling module includes a cooling plate bonded to the frame and in physical contact with one of the top end and the bottom end of the battery stack, the cooling plate including cooling channels for cooling liquid.

In some variations, the cooling plate is a first cooling plate and further comprising a second cooling plate disposed on the other one of the top end and the bottom end. In some such examples, the cooling plate extends from the front end, back end, first side, and second side of the frame. Further, the cooling channels may serpentine between the front end and the back end.

In other variations, the battery stack is compressed by the frame between the front end and the back end. In some such examples, the cooling plate is bonded to the battery stack via a thermal adhesive.

### BRIEF DESCRIPTION OF THE DRAWINGS

The present disclosure is described in the following detailed description in conjunction with the drawings, wherein:

FIG. 1 is a perspective view of an array of battery modules.

FIG. 2 is a perspective view of a battery module and integrated coldplate in accordance with the present disclosure.

FIG. 3a is a perspective view of the integrated coldplate of FIG. 2.

FIG. 3b is a perspective view of an alternative integrated coldplate arrangement.

FIG. 4 is a perspective view of a battery module and integrated coldplate in accordance with the present disclosure.

FIG. 5a is a perspective view of the coldplate of FIG. 4.

FIG. 5b is a semi-schematic plan view of an alternative coldplate useable with the battery module of FIG. 4.

FIG. 5c is a semi-schematic plan view of an alternative coldplate useable with the battery module of FIG. 4.

FIG. 5d is a semi-schematic plan view of an alternative coldplate useable with the battery module of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

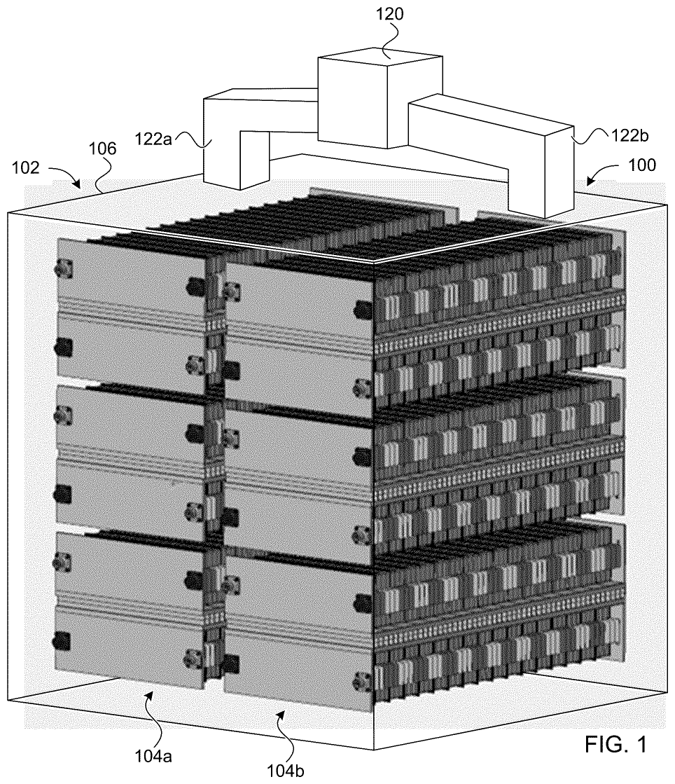

FIG. 1 illustrates an array 100 of battery modules 102 used to store large amounts of electrical energy. In various examples, the array 100 could store electrical energy to charge electric vehicles, power a home or business, or store energy to smooth demands on the energy grid. In the present example, twelve battery modules 102 are distributed evenly in a first column 104a and a second column 104b, but in various other examples, more or fewer battery modules 102 could be distributed in a different arrangement. As shown in FIG. 1, the array 100 of battery modules 102 may be disposed within a housing 106. In some examples, the housing 106 may be enclosed but in other examples, the housing 106 may permit airflow through the housing 106.

When charging and discharging electrical energy, the battery modules 102 can get very hot. For example, in various examples batteries may have a recommended operating temperature range from approximately −20 degrees Celsius (° C., approximately −5 degrees Fahrenheit (° F.)) to approximately 60° C. (approximately 140° F.). Further, the preferred operating temperatures may be between 20° C. (approximately 68° F.) to approximately 40° C. (approximately 104° F.). In some examples, the battery modules 102 need to be actively cooled to prevent the battery modules 102 from heat damage. For example, the array 100 could be cooled by passing an airflow over the battery modules 102. In some such examples, the airflow is cooled using a heat pump 120 to improve the cooling effect of the airflow. The heat pump could utilize the refrigeration cycle to act as a cold source or cool the airflow in some other known means. The cooled airflow is passed from the heat pump 120 through an inlet 122a into the housing 106. In some examples, the housing 106 may include an outlet 122b configured to pass the airflow from the housing 106 over the heat pump 120. The airflow cooled by the heat pump passes over the warm battery modules 102. The cooled airflow cools the battery modules 102 and the battery modules 102 warm the cooled air. The rate of heat transfer between the battery modules 102 and the cooled airflow is proportional to the temperature difference between the battery modules and the cooled airflow.

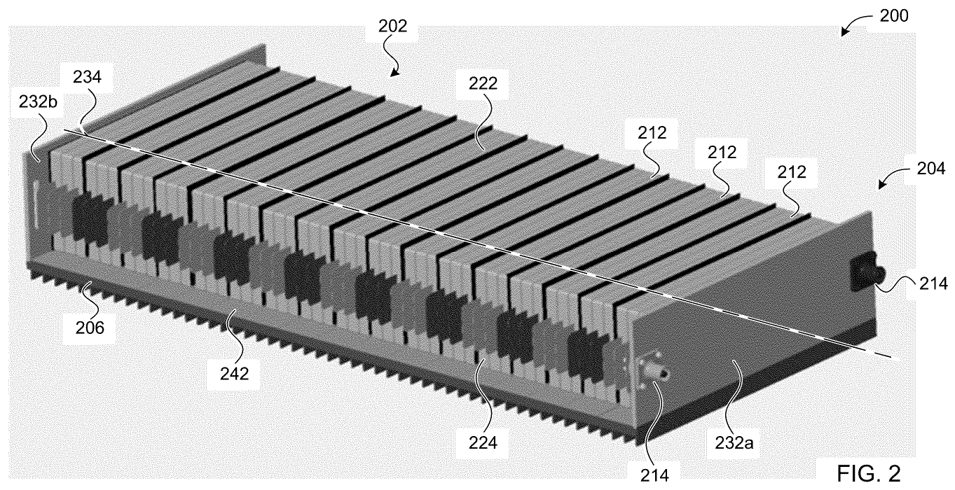

FIG. 2 illustrates an integrated battery cooling module 200 made in accordance with the present disclosure. The integrated battery cooling module 200 includes a battery stack 202 a frame 204, and a cooling plate 206. In some examples, the cooling plate 206 is integrally formed with the frame 204 to structurally support the battery stack 202. The battery stack 202 includes a plurality of battery pouch cells 212. In some variations, the battery stack 202 could include more or fewer battery pouch cells 212 or the battery pouch cells could be larger or smaller than shown in FIG. 2.

The battery stack 202 comprises a plurality of battery pouch cells 212 disposed linearly. In the present example, the battery pouch cells 212 are rectangular, but in various examples, the battery pouch cells 212 could have a different cross-sectional shape having various regular shapes (e.g., hexagonal, circular) or irregular shapes. In various examples, each battery pouch cell could be any known or future battery chemistry. In various examples, the battery pouch cells 212 can be connected in series, in parallel, or in a combination of in series and parallel. The battery stack 202 is electrically coupled to a pair of terminals 214 passing through the frame 204. In various examples, the electrical configuration of the battery pouch cells 212 is designed to provide a desired voltage across the pair of terminals 214. The pair of terminals 214 could be any terminal configuration or design known to those skilled in the art.

The battery stack 202, made of a plurality of rectangular battery pouch cells 212, forms the shape of a rectangular prism. As a result, the battery stack 202 includes a top end 222, a bottom end (not visible in FIG. 2) opposite the top end. The battery stack 202 also includes front end (not visible in FIG. 2) disposed adjacent the terminals 214, a back end (not visible in FIG. 2) disposed opposite the front end. The battery stack 202 also includes a first side (not visible in FIG. 2), and a second side 224 disposed opposite the first side. The bottom end is separated from the top end by a height defined by the front end, back end, first side, and/or second side 224. Additionally, the front end is separated from the back end by a length of the top end 222, bottom end, first side, and/or second side 224. Further, the first side is separated from the second side 224 by a width of the top end 222, bottom end, front end, and/or back end.

The frame 204 is provided to support and align the battery stack 202. In some examples, the frame 204 encapsulates the battery stack 202 but could only partially encapsulate the battery stack 202. In some examples, the frame 204 includes rigid plates that secure and/or compress the battery stack. For example, the frame 204 could include a front plate 232a and a back plate 232b that compress the battery stack 202 along a longitudinal axis 234 to ensure stability of the battery stack 202. In the present example, the frame 204 could compress the battery stack when properly secured with at least one side plate (not shown), a top plate, or a bottom plate. Additionally or alternatively, the frame 204 may include tensioning members (e.g., bolts passing through the front plate 232a and back plate 232b tightened by a nut). Electrical components, such as the pair of terminals 214, are configured to pass through the front plate 232a.

The cooling plate 206 is configured to absorb thermal energy building up in the battery stack 202 and expel the thermal energy elsewhere. In the present example, the cooling plate 206 is integrally formed with the frame 204 or bonded to the frame 204. In preferred examples, the cooling plate 206 is in physical contact with the battery stack 202 and may be secured to the battery stack 202 with a thermal adhesive. The cooling plate 206 is made of a thermally conductive material (e.g., metal or thermally conductive polymers) to improve dissipation of thermal energy from the battery stack 202. As shown in FIG. 2, the battery stack 202 includes one cooling plate 206 disposed on the bottom side of the battery stack 202, but in other examples, the battery stack 202 could include more or fewer cooling plates, and/or there could be one or more cooling plates in locations other than the bottom side of the battery stack 202. For example, the cooling module 200 could include a second cooling plate 206 disposed on the top side 222.

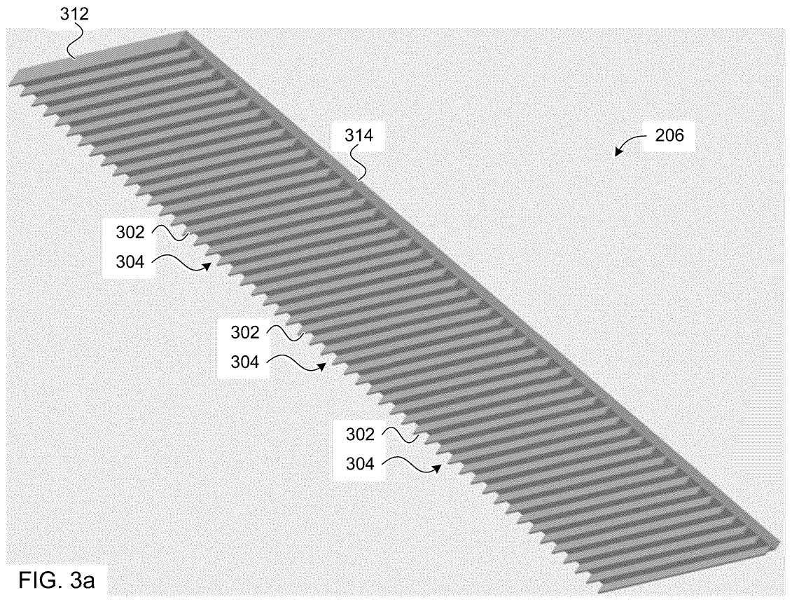

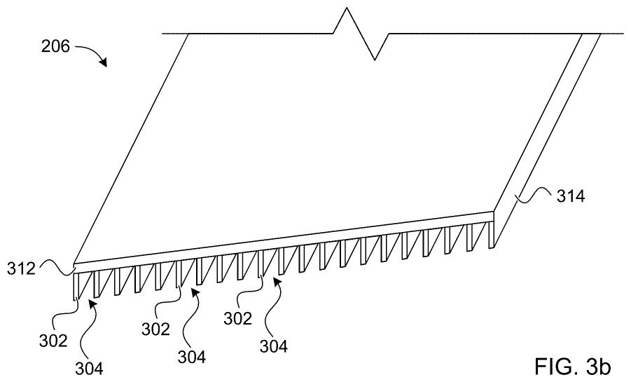

Turning to FIG. 3, the cooling plate 206 is a monolithic heat sink 300 comprising a plurality of cooling fins 302 defining cooling channels 304, but in other examples the cooling plate 206 could be made of two or more pieces. The cooling plate 206 is rectangular and includes a back end 312, a front end disposed opposite the back end 312, a first side 314, and a second side disposed opposite the first side 314. When the cooling plate 306 is coupled to the battery stack 202, the front end, the back end 312, the first side 316, and the second side are disposed adjacent to the front end, back end, first side, and second side 224 of the frame, respectively.

As shown in FIG. 3, the cooling plate 206 is an air-cooling heat sink having cooling fins 302. The cooling fins 302 are straight fins that increase the surface area of the cooling plate 206, thereby increasing the natural convective heat transfer capacity of the cooling plate 206. In the example of FIG. 3, the cooling fins 302 extend linearly from the first side 316 to the second side disposed opposite the first side 316. Alternatively, as shown in FIG. 3B, the cooling fins 302 may extend linearly from the front end to the back end 312. In yet other examples, the cooling fins 302 may define non-linear fins or extend at a non-perpendicular angle relative to the front end 312 and the first side 316.

In accordance with the present disclosure, the integrated battery cooling module 200 can replace the battery modules 102 as shown in FIG. 1. The integrated battery cooling module has better cooling properties over the battery modules 102 shown in FIG. 1. For example, the integrated battery cooling module 200 has better thermal conduction properties with the battery stack 202 than any heat sink of the battery modules 102.

When the integrated battery cooling module 200, including the cooling plate 206, is disposed in the array 100, an airflow can pass through the channels 304 and along the cooling fins 302. As a result, the airflow can convectively cool the cooling plate 206 and, at least indirectly, cool a battery stack 202 when the cooling plate 206 is bonded with the battery stack 202.

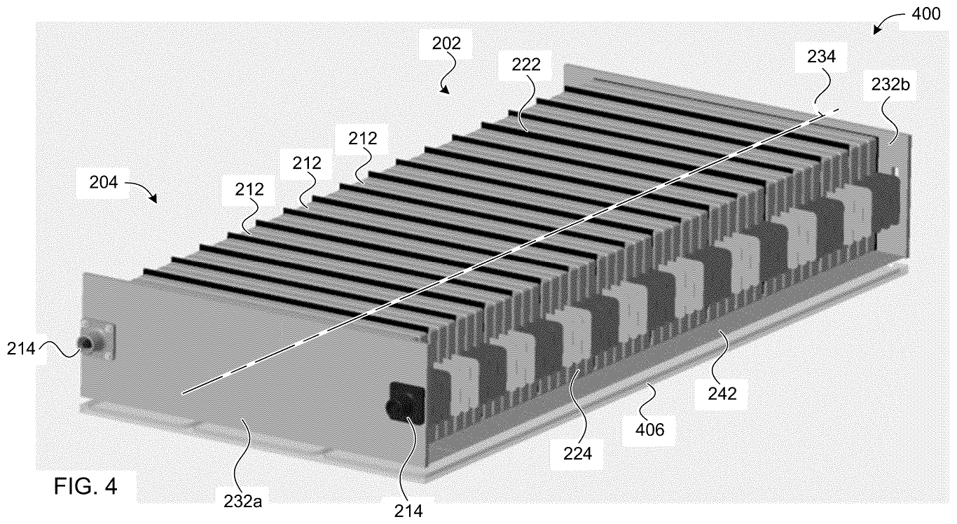

FIG. 4 illustrates an alternative integrated battery cooling module 400. The integrated battery cooling module 400 includes a battery stack 202, a frame 204, and a cooling plate 406. In the present example, the battery stack 202 and the frame 204 are identical to the battery stack 202 and the frame 204 of FIG. 2. Similar to the cooling plate 206, the cooling plate 406 is integrally formed with the frame 204 to structurally support the battery stack 202. The battery stack 202 includes a plurality of battery pouch cells 212. In some variations, the battery stack 202 could include more or fewer battery pouch cells 212 or the battery pouch cells could be larger or small than shown in FIG. 4.

The cooling plate 406 is configured to absorb thermal energy building up in the battery stack 202 and expel the thermal energy elsewhere. In the present example, the cooling plate 406 is integrally formed with the frame 204 or bonded to the frame 204. In preferred examples, the cooling plate 406 is in physical contact with the battery stack 402 and may be secured to the battery stack 202 with a thermal adhesive 242. The cooling plate 406 is made of a thermally conductive material (e.g., metal or thermally conductive polymers) to improve dissipation of thermal energy from the battery stack 202. As shown in FIG. 4, the battery stack 202 includes one cooling plate 406 disposed on the bottom side of the battery stack 202, but in other examples, the battery stack 202 could include more or fewer cooling plates 406, and/or there could be one or more cooling plates in locations other than the bottom side of the battery stack 202. For example, the cooling module 400 could include a second cooling plate 406 disposed on the top side 222.

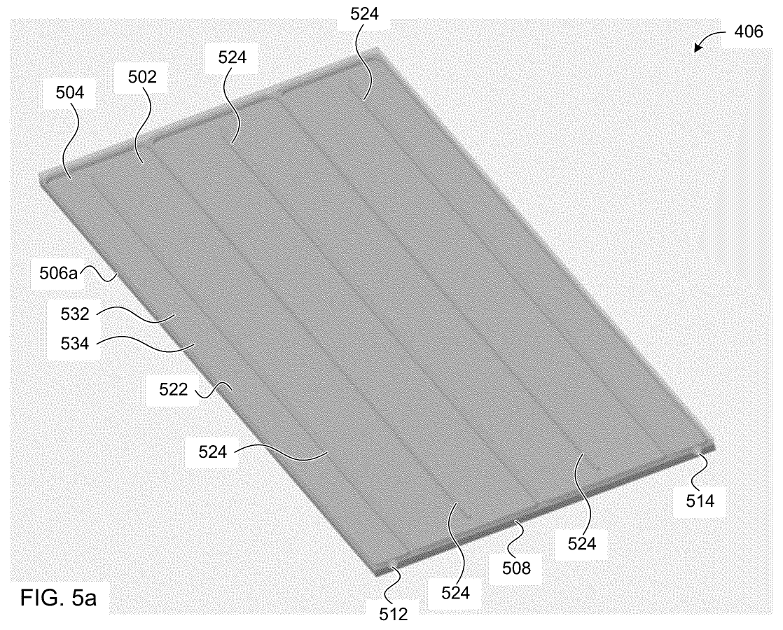

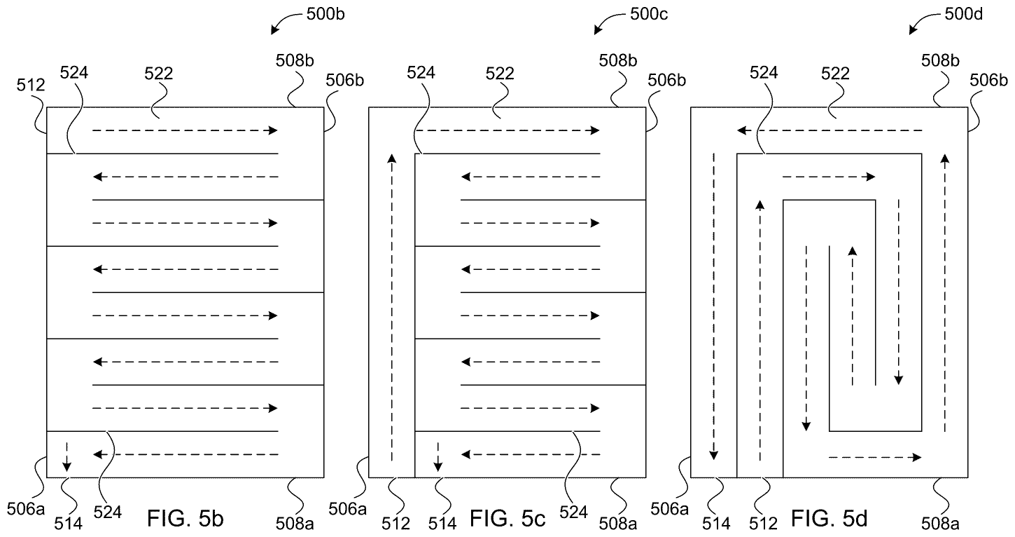

FIG. 5a illustrates the cooling plate 406. The cooling plate 406 is a liquid-cooling heat sink. Accordingly, the cooling plate 406 defines a liquid-tight enclosed volume 502 having a top side 504, a bottom side disposed opposite the top side 504, a first side 506a, a second side 506b (shown in FIG. 5b-5d) disposed opposite the first side 506a, a front end 508a, and a back end 508b (shown in FIG. 5b-5d) disposed opposite the front side 508a. When the cooling plate 406 is coupled to the battery stack 202, the front end 508a, the back end, the first side 506a, and the second side 506b are disposed adjacent to the front end, back end, first side, and second side 224 of the frame, respectively.

The cooling plate 406 includes a coolant inlet 512 and a coolant outlet 514. In the present example, both the coolant inlet 512 and the outlet 514 are disposed on the front end 508, but in other examples, the coolant inlet 512 and/or the outlet 514 could be disposed elsewhere on the cooling plate 406. A liquid is passed into the cooling plate 406 via the coolant inlet 512 and the coolant at least partially fills the enclosed volume 502 before passing through the coolant outlet 514 and out of the coolant plate 406. In various examples, the liquid may comprise a coolant having improved heat transfer characteristics. For example, the coolant could comprise a water-based solution such as ethylene glycol, a silicon oil, ester blends, or other known coolants.

Furthermore, the cooling plate 406 includes a serpentine flow path 522 defined by a plurality of partitions 524. The plurality of partitions 524 extend from a bottom surface of the cooling plate 406 and a top surface of the cooling plate 406 but do not fully extend between the front end 508a and the back end 508b of the cooling plate 406. As a result, the liquid can pass along a circuitous path from the inlet 512 and the outlet 514. The circuitous path distributes liquid evenly throughout the enclosed volume 502 and cools most of the top and bottom surfaces 532, 534.

In the present example, the circuitous path from the inlet 512 and the outlet 514 passes back and forth from the front end 508a and the back end 508b. But, the circuitous path could extend in any two-dimensional path and the path may be optimized for heat transfer. As shown in FIGS. 5b, 5c, and 5d, the circuitous path could follow any two-dimensional path and the inlet 512 and outlet 514 could be disposed anywhere on the cooling plate 406.

As illustrated semi-schematically in FIG. 5b, an alternative cooling plate 500b includes a circuitous path of the liquid that may pass back and forth from the first side 506a to the second side 506b. As a result, the inlet 512 and the outlet 514 are not disposed on the same surface of the alternative cooling plate 500b. In the example of FIG. 5b, the inlet 512 is disposed on the first side 506a and the outlet 514 is disposed on the front end 508a. The liquid flows from the inlet 512 to the outlet 514 as generally shown in FIG. 5b by the dashed arrows. In various examples, the orientation of the inlet 512 and the outlet 514 can be reversed.

As illustrated semi-schematically in FIG. 5c, an alternative cooling plate 500c includes a circuitous path of the liquid that may pass along a length of the cooling plate 500c from the front end 508a to the back end 508b before passing back and forth perpendicular to the inlet 512 and out through the outlet 514. As illustrated in FIG. 5c, the inlet 512 and the outlet 514 are adjacent to one another on the same surface, but could be disposed approximately adjacent to one another on different surfaces. Similar to FIG. 5b, the liquid flows from the inlet 512 to the outlet 514 as shown by the dashed arrows. In various examples, the inlet 512 and the outlet 514 can be reversed.

As illustrated semi-schematically in FIG. 5d, an alternative cooling plate 500d includes a circuitous path of the liquid that may pass clockwise from an inlet 512 and counterclockwise to the outlet 514. As illustrated in FIG. 5d, the inlet 512 and the outlet 514 are disposed adjacent one another on the front end 508a but could be disposed on different surfaces of the alternative cooling plate 500d. Similar to FIGS. 5b and 5d, the liquid flows from the inlet 512 to the outlet 514 as shown by the dashed arrows. In various examples, the inlet 512 and the outlet 514 can be reversed.

In accordance with the present disclosure, the present integrated battery cooling module provides many benefits over the known designs. For instance, integrating a cooling plate into the frame holding a battery stack reduces the overall volume of the battery module because the heat sink is integrally formed in the frame. As a result, because the battery module has less volume than a typical battery module, the volumetric energy density of the array of battery modules can be increased. Furthermore, the cooling plates provide better cooling capacity than typical battery modules because the cooling plates are in direct contact with the battery stacks and integrated into the frame, thus utilizing conductive heat transfer instead of convective heat transfer. In addition, the weight of the integrated battery cooling module is less than a typical battery module. The lighter battery module is better for assembly and transportation.

Additionally, in various examples, the cooling plates 206, 406, 506b, 506c, and 506d are interchangeable. As a result, the integrated battery cooling module having one of the cooling plates 206, 406, 506b, 506c, and 506d can be replaced by any other cooling plate 206, 406, 506b, 506c, and 506d. As a result, new or alternative cooling plates can be readily installed into the array 100 of integrated battery cooling modules.

Those skilled in the art will recognize that a wide variety of modifications, alterations, and combinations can be made with respect to the above-described examples without departing from the spirit and scope of the invention(s) disclosed herein, and that such modifications, alterations, and combinations are to be viewed as being within the ambit of the inventive concept(s).

What is claimed is:

1. An integrated battery cooling module, comprising:
a battery stack having a top end, a front end, a bottom end separated from the top end by a height of the front end, a back end separated from the front end by a length of the top end;
a frame at least partially enclosing the battery stack on the front end and the back end, the frame compressing the battery stack between the front end and the back end; and
a cooling plate bonded to and structurally reinforcing the frame and in physical contact with one of the top end and the bottom end of the battery stack.

2. The integrated battery cooling module of claim 1, wherein the cooling plate is a first cooling plate and further comprising a second cooling plate bonded to the frame and in physical contact with the other of the top and the bottom end of the battery stack.

3. The integrated battery cooling module of claim 2, wherein the first and second cooling plates each include a plurality of cooling fins.

4. The integrated battery cooling module of claim 2, wherein the first and second cooling plates each include cooling channels for circulating liquid.

5. The integrated battery cooling module of claim 2, wherein the cooling channels serpentine between the front end and the back end.

6. The integrated battery cooling module of claim 1, wherein the cooling plate is one of an air-cooling heat sink and a liquid-cooling heat sink and the cooling plate is interchangeable with the other of the air-cooling heat sink and the liquid-cooling heat sink.

7. The integrated battery cooling module of claim 1, wherein the cooling plate is bonded to the battery stack via a thermal adhesive.

8. The integrated battery cooling module of claim 1, wherein the cooling plate is integrally formed with the frame.

9. An integrated battery cooling module, comprising:
a battery stack having a top end, a bottom end, a front end, a back end, a first side, and a second side;
a frame at least partially enclosing the battery stack on the front end, back end, first side, and second side; and
a cooling plate bonded to the frame and in physical contact with one of the top end and the bottom end of the battery stack, the cooling plate including a plurality of cooling fins.

10. The integrated battery cooling module of claim 9, wherein the cooling plate is a first cooling plate and further comprising a second cooling plate disposed on the other one of the top end and the bottom end.

11. The integrated battery cooling module of claim 9, wherein the cooling plate extends from the front end, back end, first side, and second side of the frame.

12. The integrated battery cooling module of claim 11, wherein the cooling fins extend from the first side to the second side.

13. The integrated battery cooling module of claim 11, wherein the battery stack is compressed by the frame between the front end and the back end.

14. The integrated battery cooling module of claim 9, wherein the cooling plate is bonded to the battery stack via a thermal adhesive.

15. An integrated battery cooling module, comprising:
a battery stack having a top end, a bottom end, a front end, a back end, a first side, and a second side;
a frame at least partially enclosing the battery stack on the front end, back end, first side, and second side; and
a cooling plate bonded to the frame and in physical contact with one of the top end and the bottom end of the battery stack, the cooling plate including cooling channels for cooling liquid.

16. The integrated battery cooling module of claim 15, wherein the cooling plate is a first cooling plate and further comprising a second cooling plate disposed on the other one of the top end and the bottom end.

17. The integrated battery cooling module of claim 15, wherein the cooling plate extends from the front end, back end, first side, and second side of the frame.

18. The integrated battery cooling module of claim 17, wherein the cooling channels serpentine between the front end and the back end.

19. The integrated battery cooling module of claim 15, wherein the battery stack is compressed by the frame between the front end and the back end.

20. The integrated battery cooling module of claim 15, wherein the cooling plate is bonded to the battery stack via a thermal adhesive.
